(19) United States
(12) Patent Application Publication
(10) Pub. No.: US 2026/0145357 A1
(43) Pub. Date: May 28, 2026

(54) OUTDOOR TOOL AND EDDY-CURRENT-DRIVEN LUBRICATION SYSTEM

(71) Applicant: Milwaukee Electric Tool Corporation, Brookfield, WI (US)

(72) Inventor: Brian Rothe, Hartland, WI (US)

(21) Appl. No.: 19/395,994

(22) Filed: Nov. 20, 2025

Related U.S. Application Data
(60) Provisional application No. 63/723,647, filed on Nov. 22, 2024.
(60) Provisional application No. 63/735,571, filed on Dec. 18, 2024.

(51) Int. Cl. B27B 17/12; B27B 17/02

(52) U.S. Cl. CPC B27B 17/12; B27B 17/02

(57) ABSTRACT

Outdoor tools and eddy-current-driven lubrication systems are provided. A lubrication assembly may include a motor assembly, a drive plate, a driven rotor, a cam plate, and a positive displacement pump. The drive plate may be mechanically coupled to the motor assembly to rotate therewith. The driven rotor may be spaced apart from the drive plate. The driven rotor may include a support substrate and one or more magnetic elements fixed to the support substrate to rotate therewith. The one or more magnetic elements may be magnetically engaged with the drive plate to generate an eddy current therewith. The cam plate may be attached to the support substrate to rotate therewith. The positive displacement pump may be in mechanical communication with the cam plate to motivate pumping of a lubricant fluid based on rotation of the cam plate.

### CROSS-REFERENCE TO RELATED APPLICATIONS

The present application claims priority to U.S. Application Ser. No. 63/723,647 filed on Nov. 22, 2024 and U.S. Application Ser. No. 63/735,571 filed on Dec. 31, 2024, the disclosures of which are incorporated by reference herein in their entirety.

### FIELD

The present disclosure relates generally to lubrication systems for outdoor power tools, e.g., chain saws, pole saws and the like.

### BACKGROUND

Outdoor tools, such as pole saws and handheld chainsaws, are used to perform outdoor tasks such as cutting tree branches and other vegetation. Pole saws and chainsaws cut through material using chains with cutting teeth. The chain is typically disposed in a track on a guide bar. The chain moves relative to the track, advancing the cutting teeth along the material being cut.

Frictional resistance between the chain and guide bar decreases saw efficiency. That is, the additional resistance between the chain and guide bar results in decreased energy capacity and fewer cuts which can be made between charging or refueling. To solve this problem, lubrication may be introduced between the chain and guide bar. However, too much lubrication can attract debris, interfere with electronic components of the tool, create a worse user experience, or even cause dripping. Many existing systems require complex gearing and systems to deliver lubricant to the tool. For instance, a worm drive may be utilized to directly transfer mechanical energy from a primary motor to a lubricant pump (e.g., centrifugal pump or other pump utilizing kinetic energy on the lubricant to induce pressure energy for pumping). Such systems may be expensive, inefficient, difficult to assemble, or require significant space within the tool. Some systems may even be at risk for leaking lubricant when the tool is not in use, especially over time.

Accordingly, improved outdoor tool oiling systems are desired in the art. In particular, outdoor tools or lubrication systems that provide sufficient lubrication while being relatively robust, energy efficient, or compact would be advantageous.

### BRIEF DESCRIPTION

Aspects and advantages of the present disclosure will be set forth in part in the following description, or may be obvious from the description, or may be learned through practice of the technology.

In accordance with one embodiment, a lubrication system for a power tool is provided. The lubrication system may include a motor assembly, a drive plate, a driven rotor, a cam plate, and a positive displacement pump. The drive plate may be mechanically coupled to the motor assembly to rotate therewith. The driven rotor may be spaced apart from the drive plate. The driven rotor may include a support substrate and one or more magnetic elements fixed to the support substrate to rotate therewith. The one or more magnetic elements may be magnetically engaged with the drive plate to generate an eddy current therewith. The cam plate may be attached to the support substrate to rotate therewith. The positive displacement pump may be in mechanical communication with the cam plate to motivate pumping of a lubricant fluid based on rotation of the cam plate.

In accordance with another embodiment, a tool is provided. The tool includes a motor assembly, a tool unit, and a lubrication system. The tool unit may be powered by the motor assembly. The tool unit may include a guide bar and a chain circumscribing a portion of the guide bar. The lubrication system provides lubricant to the chain. The lubrication system may include a drive plate, a driven rotor, a cam plate, and a positive displacement pump. The drive plate may be mechanically coupled to the motor assembly to rotate therewith. The driven rotor may be spaced apart from the drive plate. The driven rotor may include a support substrate and one or more magnetic elements fixed to the support substrate to rotate therewith. The one or more magnetic elements may be magnetically engaged with the drive plate to generate an eddy current therewith. The cam plate may be attached to the support substrate to rotate therewith. The positive displacement pump may be in mechanical communication with the cam plate to motivate pumping of a lubricant fluid to the chain based on rotation of the cam plate.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of an outdoor tool in accordance with embodiments of the present disclosure;

FIG. 2 is a perspective view of a lubrication assembly in accordance with embodiments of the present disclosure;

FIG. 3 is a bottom perspective view of a portion of the exemplary lubrication assembly of FIG. 2;

FIG. 4 is a first perspective view of a pump support of the exemplary lubrication assembly of FIG. 2;

FIG. 5 is a second perspective view of a pump support of the exemplary lubrication assembly of FIG. 2;

FIG. 6 is a sectional view of a portion of the exemplary lubrication assembly of FIG. 2, taken along the lines 6-6; and

FIG. 7 illustrates a schematic representation of operation of a lubrication system in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, tools described herein can utilize lubrication systems that do not require direct mechanical coupling between a motor and the pump. For instance, the lubrication system may include an array or system for inducing one or more eddy currents in response to rotation of the motor. The eddy currents may drive rotation of a driven plate, which in turn, may move the pump to motivate pumping of a lubricant. Additionally or alternatively, the pump may include or be provided as a positive displacement pump. Notably, the tools or lubrication systems described herein may be relatively robust, energy efficient, or compact (e.g., in comparison to lubrication systems or assemblies in existing outdoor tools). In some instances, air entrapment within the pump may be prevented. In additional or alternative instance, flow (e.g., volumetric flow rate) of the lubricant may be monitored or determined with no additional wetted components in the lubrication system, which may in turn reduce size, complexity, or risks of leaking.

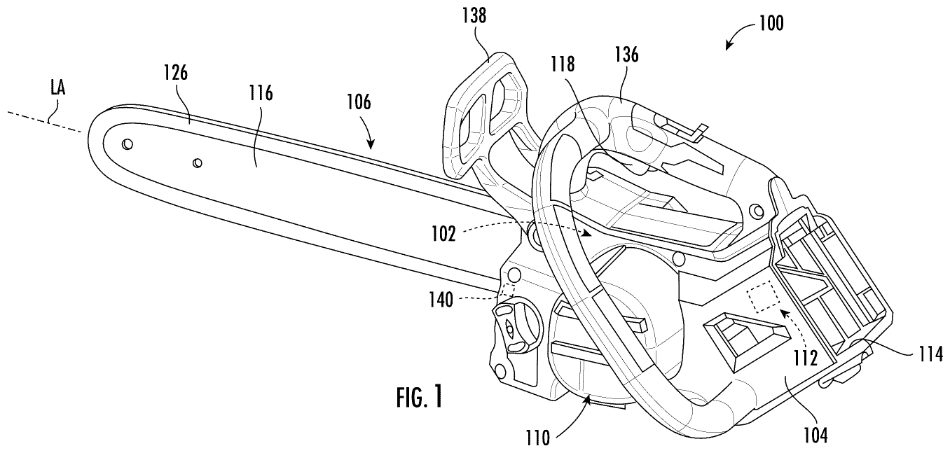

Referring now to the drawings, FIG. 1 illustrates a perspective view of a tool 100 in accordance with exemplary embodiments of the present disclosure. In particular, the tool 100 shown in FIG. 1 is a chain saw. The tool 100 has a lubrication system 102 disposed within a housing 104 of the tool 100. The tool 100 can further include a guide bar assembly 106 including a guide bar 116 that receives a chain 126, e.g., circumscribed around the guide bar 116. As will be described in greater detail below, the tool 100 may further include a motor assembly 110 and lubrication system 102 (e.g., within the housing 104) driven, at least in part, by motor assembly 110. When assembled, one or more hoses or conduits connected to the lubrication system 102 may generally direct or deliver liquid lubricant (e.g., lubricant oil) from the lubrication system 102 to the guide bar assembly 106 (e.g., as would be understood).

The tool 100 can include a variety of features and configurations to facilitate the handling and operation of the tool 100 by a user. For instance, the housing 104 may include a first handle 136 (e.g., a top handle) coupled between a battery pack receptacle or receiver 114 and a front portion of the housing 104. As such, the first handle 136 extends in a direction along the longitudinal axis LA of the guide bar 116. In addition, the housing 104 includes a second handle 138 (e.g., an elongated curved bar) coupled between the first handle 136 and a sidewall of the battery pack receptacle 114.

A user interface, e.g., a trigger 118, can be disposed at a location whereby an operator can control operation of the tool 100, such as on the first handle 136. The trigger 118 can control the motor assembly 110 of the tool 100 to drive the chain 126 along the guide bar 116. By way of non-limiting example, the motor assembly 110 can include a motor having an output or drive shaft. The drive shaft can be in communication with the chain 126, e.g., through a transmission having a drive gear, so as to move the chain 126 along the guide bar 116. For instance, the drive gear may be rotatably coupled to the transmission, and the chain 126 may be in operable communication with the drive gear (e.g., the chain 126 may circumscribe a portion of the drive gear) such that the drive gear can drive the chain 126 about the guide bar 116. When the trigger 118 is activated, e.g., depressed, the speed of the motor assembly 110 can increase. Conversely, when the trigger 118 is deactivated, e.g., not depressed, the motor assembly 110 can stop.

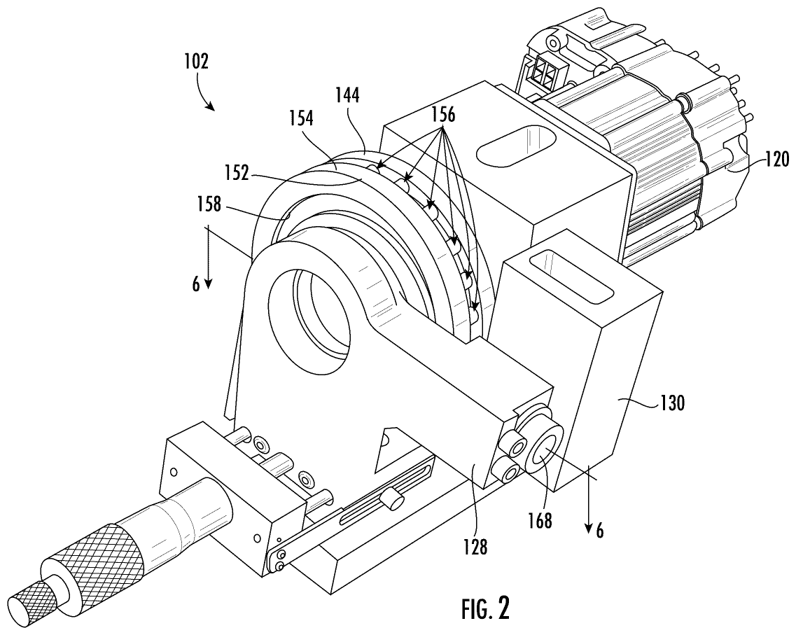

The motor assembly 110 may include or be provided as any generational source of power to directly, or indirectly, move the chain 126 around the guide bar 116, such as a system motor 120 provided as an electric motor (FIG. 2) or internal combustion engine. Optionally, the motor assembly 110 may be a variable speed motor and a relative activated position of the trigger 118 can inform the speed of the variable speed motor. That is, the operator can control the speed of the chain 126 along the guide bar 116 based on how far the trigger 118 is depressed. A secondary user interface, e.g., a power button (not shown), can be used to control another aspect of the tool 100. The power button can include, for example, a toggle which can be moved between ON and OFF positions. The tool 100 may not function when the power button is in the OFF position.

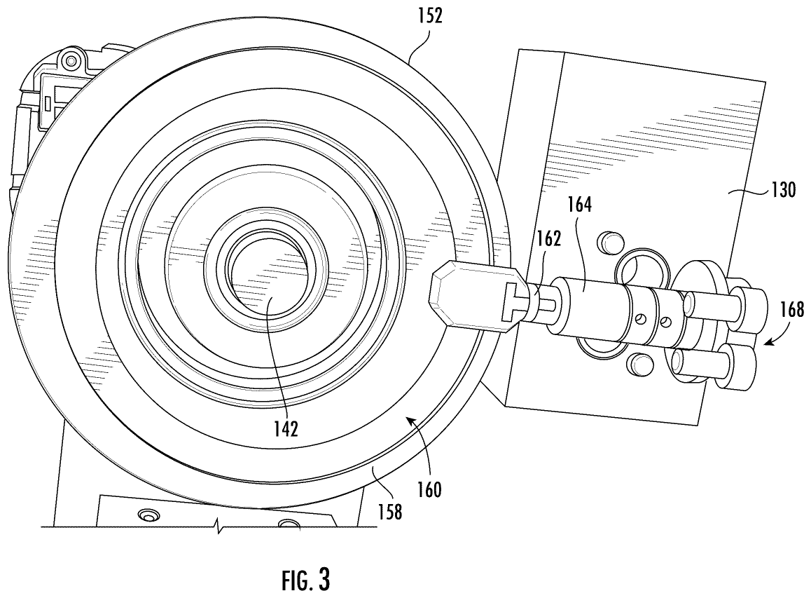

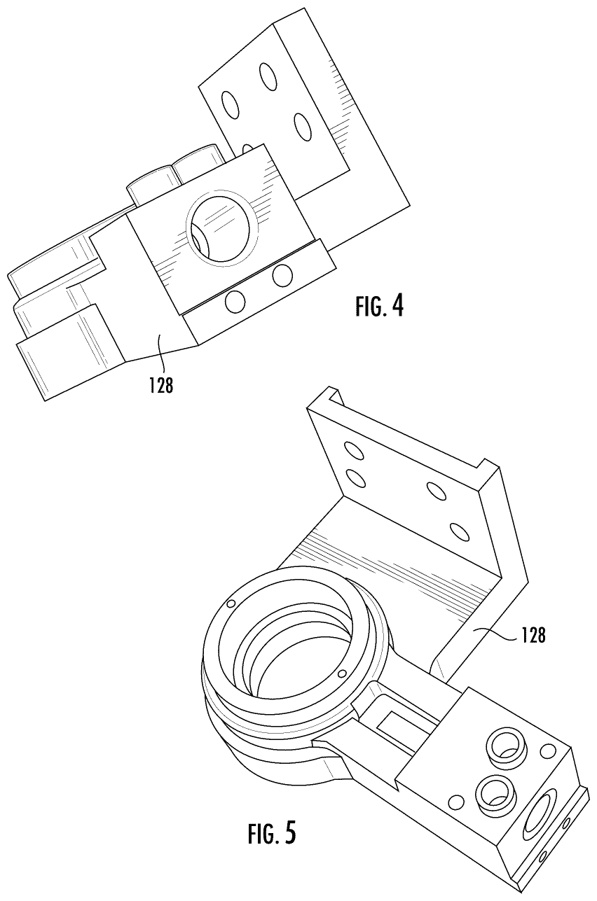

Turning now generally to FIGS. 2 through 6, various views are provided to illustrate a lubrication system 102, and aspects of the same, according to exemplary embodiments. Generally, a system motor 120 (e.g., motor assembly 110) is attached to one or more portions of lubrication system 102. In particular, system motor 120 may be mechanically coupled or fixed to a drive plate 144 to rotate the same. As will be described in greater detail below, drive plate 144 may be indirectly coupled to or associated with one or more intermediate components to drive or motivate the flow of lubricant from a provided oil tank or lubricant reservoir 130 (e.g., mounted to or enclosed within housing 104—FIG. 1) to the chain 126 or guide bar 116 (FIG. 1).

In some embodiments, system motor 120 includes a drive shaft 142 extending along an axial direction A, which defines an axis of rotation for motor 120. Drive plate 144 may be fixed to drive shaft 142 and, thus, rotate simultaneously to or in concert with drive shaft 142 about the axial direction A. Thus, drive shaft 142 and drive plate 144 may be coaxial. As shown, drive plate 144 may include or be provided as a magnetically permeable or conductive disk that extends radially from drive shaft 142 (or axial direction A generally). In other words, a disk formed from a magnetically permeable or conductive metal (e.g., non-ferrous metal) may be included with or provided as the drive plate 144. Optionally, a circumferential recess 146 may be defined in the conductive disk, such as on an upper or motor-facing surface 150 of conductive disk.

In optional embodiments, a motor fan 148 is rotationally coupled or fixed to the motor assembly 110 and the drive plate 144 to rotate therewith. For instance, motor fan 148, which includes one or more fan or impeller blades, may be fixed to drive shaft 142 (e.g., between a base of the system motor 120 and drive plate 144 relative to the axial direction A). In the illustrated embodiments, motor fan 148 is supported on the conductive disk. Specifically, motor fan 148 is provided on the upper or motor-facing surface 150 of the conductive disk. In some such embodiments, motor fan 148 is further seated within the circumferential recess 146.

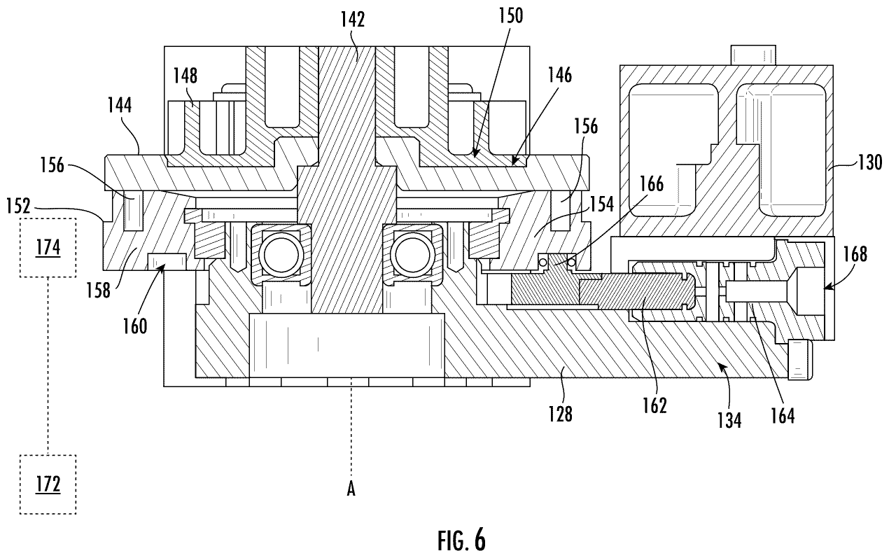

Apart from the drive plate 144, lubrication system 102 further includes a driven rotor 152. In particular, driven rotor 152 may be spaced apart from drive plate 144 such that neither is in direct contact with the other. As shown in the illustrated embodiments, the driven rotor 152 may be axially spaced apart from the drive plate 144. Although drive plate 144 may influence or induce rotation at the driven rotor 152 (as will be described in detail below), the driven rotor 152 may be mechanically or rotationally decoupled from the drive plate 144 or the drive shaft 142. Nonetheless, in optional embodiments, such as those illustrated in FIG. 6, the drive shaft 142 may extend through or at least coaxial with driven rotor 152. Nonetheless, one or more bearings or bearing arrays may be radially disposed between the drive shaft 142 and driven rotor 152 such that rotation of the drive shaft 142 is not directly transferred to the driven rotor 152.

Generally, the driven rotor 152 includes a support substrate 154 (e.g., disk substrate) and one or more magnetic elements 156 (e.g., permanent magnets). The magnetic elements 156 may be, for instance, fixed to the support substrate 154 to rotate therewith. In some embodiments, the one or more magnetic elements 156 includes a plurality of circumferentially spaced (e.g., equally spaced about the axial direction A) magnetic elements 156. As shown, the magnetic elements 156 may be embedded within the support substrate 154. The magnetic elements 156 may be arrayed such that the magnetic pole directed or toward the drive plate 144 is alternated. Moreover, the one or more magnetic elements 156 may be magnetically engaged with the drive plate 144. In turn, rotation of the drive plate 144 may generate an eddy current at the one or more magnetic elements 156 of the driven rotor 152 (e.g., as would be understood). The driven rotor 152 may be rotatably mounted about or extend radially outward from the axial direction A. In turn, rotation of the drive plate 144 may induce the driven rotor 152 to separately rotate (e.g., about the axial direction A).

In some embodiments, a cam plate 158 is attached to the support substrate 154. In particular, the cam plate 158 may be rotationally fixed to support substrate 154 to rotate therewith. Additionally or alternatively, cam plate 158 may be axially disposed such that drive plate 144 or the one or more magnetic elements 156 is/are positioned between cam plate 158 and system motor 120. In certain embodiments, cam plate 158 defines a cam groove 160. As shown, the cam groove 160 may be defined about the central axis of the driven rotor 152 (e.g., the axial direction A). For instance, the cam groove 160 may be defined on a bottom or

As shown, cam plate 158 may formed or disposed on a bottom or motor-opposing surface of driven rotor 152 (e.g., opposite of the one or more magnetic elements 156). In turn, cam plate 158 may be directed away from the system motor 120. The cam groove 160 may have an eccentric path or shape relative to the central axis. Thus, a circumferentially static member (e.g., groove tab 166) engaged with or received within the cam groove 160 may be alternated along a radial direction between an inward position (e.g., proximal to the central axis) and an outward position (e.g., distal to the central axis).

Generally, a lubricant pump 134 may be in communication with the cam plate 158 (e.g., to motivate pumping of the lubricant fluid). In some embodiments, a positive-displacement pump 134 is provided. Specifically, the positive-displacement pump 134 may be in mechanical communication with the cam plate 158 to motivate pumping of a lubricant fluid based on rotation of the cam plate 158. In the illustrated embodiments, positive-displacement pump 134 includes or is provided as a linear pump and, in turn, includes a linear piston 162 and a pump cylinder 164 within which the linear piston 162 is slidably received. As shown, the pump cylinder 164 defines a lubricant outlet 168 (e.g., upstream of lubricant output 140) and is supported on a pump support 128 that is generally static within the housing 104 of the tool 100 (FIG. 1). Moreover, the pump cylinder 164 is in communication with an lubricant reservoir 130. Optionally, lubricant reservoir 130 may be mounted above the pump cylinder 164 (e.g., on the pump support 128).

The linear piston 162 may be engaged with the cam plate 158 such that rotation of the cam plate 158 drives linear movement or reciprocation of the piston relative to the pump cylinder 164. Thus, the linear piston 162 may be driven to pump fluid to and from the cylinder based on movement of the cam plate 158. In exemplary embodiments, a groove tab 166 is fixed to or extends axially from linear piston 162 (e.g., perpendicular or non-parallel to the linear axis of piston movement or the pump cylinder 164 generally) outside of the pump cylinder 164. As shown, the groove tab 166 may be received within the cam groove 160. In turn, as the cam plate 158 rotates, the groove tab 166 (and thus the linear piston 162) may be alternated along a radial direction between an inward position (e.g., proximal to the central axis) and an outward position (e.g., distal to the central axis).

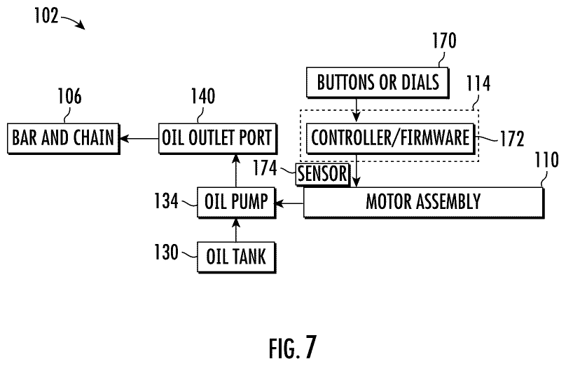

FIG. 7 shows a schematic representation of the operation of the lubrication system 102. The pump 134 may be operated, e.g., controlled and actuated, by the motor assembly 110. The tool 100 has a control assembly 112 that includes one or more inputs 170 such as buttons or dials to control operation of the tool 100, including but not limited to the trigger 118. The control assembly 112 includes a controller 174, e.g., a printed circuit board (PCB) or other hardware and firmware, which can receive an input from the input(s) 170. The controller 174 is operatively coupled to motor assembly 110 to control the positive displacement pump 134 simultaneously with motor assembly 110. The motor assembly 110 may be electrically driven by the controller 174 to cause rotation of the Thus, when the motor assembly 110 is driven by the controller 174, the system pump 134 is actuated (e.g., by the driven rotor 152—FIG. 6) to pump lubricant 132 from the lubricant reservoir 130 to the lubricant output 140, thereby delivering lubricant 132 to the bar and chain assembly 106.

In some embodiments, a rotational sensor 174 is provided in operative communication (e.g., electrical or wireless communication) with the controller 174. The rotational sensor 174 may be generally configured to detect an operational state of the lubrication system 102 (e.g., on/off or otherwise disabled, deactivated), or a flow rate of lubricant 132 through the pump 134. For instance, the rotational sensor 174 may be configured to detect the eddy current generated at the driven rotor 152. In turn, the controller may be configured to determine an operational state based on the detected eddy current. A determined absence of rotation may indicate the lubrication system 102 is blocked. Determined rotation (e.g., rotational velocity) within a predefined range may indicate adequate operation of the lubrication system 102. Determined rotation above the predefined range may indicate insufficient lubricant (e.g., insufficient lubricant within the lubricant reservoir 130).
Further aspects of the disclosure are provided by one or more of the following embodiments:
A lubrication system for a power tool, comprises: a motor assembly; a drive plate mechanically coupled to the motor assembly to rotate therewith; a driven rotor spaced apart from the drive plate, the driven rotor comprising a support substrate and one or more magnetic elements fixed to the support substrate to rotate therewith, the one or more magnetic elements being magnetically engaged with the drive plate to generate an eddy current therewith; a cam plate attached to the support substrate to rotate therewith; and a positive displacement pump in mechanical communication with the cam plate to motivate pumping of a lubricant fluid based on rotation of the cam plate.
The lubrication system of any one or more of the embodiments, wherein the positive displacement pump comprises a linear piston and a pump cylinder within which the linear piston is slidably received, and wherein the linear piston is engaged with the cam plate to motivate linear movement of the linear piston relative to the pump cylinder.
The lubrication system of any one or more of the embodiments, wherein the cam plate defines a cam groove about a central axis of the driven rotor.
The lubrication system of any one or more of the embodiments, wherein the positive displacement pump comprises a linear piston and a groove tab received within the cam groove.
The lubrication system of any one or more of the embodiments, wherein the cam groove is defined on a bottom face of the driven rotor, opposite of the one or more magnetic elements.
The lubrication system of any one or more of the embodiments, wherein driven rotor is axially spaced apart from the drive plate.
The lubrication system of any one or more of the embodiments, wherein the motor assembly comprises a drive shaft to which the drive plate is fixed, and wherein the drive shaft is coaxial with and rotationally decoupled from the driven rotor.
The lubrication system of any one or more of the embodiments, further comprising a motor fan rotationally coupled to the motor assembly and the drive plate to rotate therewith.
The lubrication system of any one or more of the embodiments, wherein the one or more magnetic elements comprises a plurality of circumferentially spaced magnetic elements embedded within the support substrate.
The lubrication system of any one or more of the embodiments, further comprising a rotational sensor configured to detect the eddy current and a controller configured to determine an operational state based on the detected eddy current.
A tool comprising: a motor assembly; a tool unit powered by the motor assembly, the tool unit comprising a guide bar and a chain circumscribing a portion of the guide bar; and a lubrication system that provides lubricant to the chain, the lubrication system comprising: a drive plate mechanically coupled to the motor assembly to rotate therewith, a driven rotor spaced apart from the drive plate, the driven rotor comprising a support substrate and one or more magnetic elements fixed to the support substrate to rotate therewith, the one or more magnetic elements being magnetically engaged with the drive plate to generate an eddy current therewith, a cam plate attached to the support substrate to rotate therewith, and a positive displacement pump in mechanical communication with the cam plate to motivate pumping of a lubricant fluid to the chain based on rotation of the cam plate.
The tool of any one or more of the embodiments, wherein the positive displacement pump comprises a linear piston and a pump cylinder within which the linear piston is slidably received, and wherein the linear piston is engaged with the cam plate to motivate linear movement of the linear piston relative to the pump cylinder.
The tool of any one or more of the embodiments, wherein the cam plate defines a cam groove about a central axis of the driven rotor.
The tool of any one or more of the embodiments, wherein the positive displacement pump comprises a linear piston and a groove tab received within the cam groove.
The tool of any one or more of the embodiments, wherein the cam groove is defined on a bottom face of the driven rotor, opposite of the one or more magnetic elements.
The tool of any one or more of the embodiments, wherein driven rotor is axially spaced apart from the drive plate.
The tool of any one or more of the embodiments, wherein the motor assembly comprises a drive shaft to which the drive plate is fixed, and wherein the drive shaft is coaxial with and rotationally decoupled from the driven rotor.
The tool of any one or more of the embodiments, further comprising a motor fan rotationally coupled to the motor assembly and the drive plate to rotate therewith.
The tool of any one or more of the embodiments, wherein the one or more magnetic elements comprises a plurality of circumferentially spaced magnetic elements embedded within the support substrate.
The tool of any one or more of the embodiments, further comprising a rotational sensor configured to detect the eddy current and a controller configured to determine an operational state based on the detected eddy current.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A lubrication system for a power tool, comprising:
a motor assembly;
a drive plate mechanically coupled to the motor assembly to rotate therewith;
a driven rotor spaced apart from the drive plate, the driven rotor comprising a support substrate and one or more magnetic elements fixed to the support substrate to rotate therewith, the one or more magnetic elements being magnetically engaged with the drive plate to generate an eddy current therewith;
a cam plate attached to the support substrate to rotate therewith; and
a positive displacement pump in mechanical communication with the cam plate to motivate pumping of a lubricant fluid based on rotation of the cam plate.

2. The lubrication system of claim 1, wherein the positive displacement pump comprises a linear piston and a pump cylinder within which the linear piston is slidably received, and wherein the linear piston is engaged with the cam plate to motivate linear movement of the linear piston relative to the pump cylinder.

3. The lubrication system of claim 1, wherein the cam plate defines a cam groove about a central axis of the driven rotor.

4. The lubrication system of claim 3, wherein the positive displacement pump comprises a linear piston and a groove tab received within the cam groove.

5. The lubrication system of claim 3, wherein the cam groove is defined on a bottom face of the driven rotor, opposite of the one or more magnetic elements.

6. The lubrication system of claim 1, wherein driven rotor is axially spaced apart from the drive plate.

7. The lubrication system of claim 1, wherein the motor assembly comprises a drive shaft to which the drive plate is fixed, and wherein the drive shaft is coaxial with and rotationally decoupled from the driven rotor.

8. The lubrication system of claim 1, further comprising a motor fan rotationally coupled to the motor assembly and the drive plate to rotate therewith.

9. The lubrication system of claim 1, wherein the one or more magnetic elements comprises a plurality of circumferentially spaced magnetic elements embedded within the support substrate.

10. The lubrication system of claim 1, further comprising a rotational sensor configured to detect the eddy current and a controller configured to determine an operational state based on the detected eddy current.

11. A tool comprising:
a motor assembly;
a tool unit powered by the motor assembly, the tool unit comprising a guide bar and a chain circumscribing a portion of the guide bar; and
a lubrication system that provides lubricant to the chain, the lubrication system comprising:
a drive plate mechanically coupled to the motor assembly to rotate therewith,
a driven rotor spaced apart from the drive plate, the driven rotor comprising a support substrate and one or more magnetic elements fixed to the support substrate to rotate therewith, the one or more magnetic elements being magnetically engaged with the drive plate to generate an eddy current therewith,
a cam plate attached to the support substrate to rotate therewith, and
a positive displacement pump in mechanical communication with the cam plate to motivate pumping of a lubricant fluid to the chain based on rotation of the cam plate.

12. The tool of claim 11, wherein the positive displacement pump comprises a linear piston and a pump cylinder within which the linear piston is slidably received, and wherein the linear piston is engaged with the cam plate to motivate linear movement of the linear piston relative to the pump cylinder.

13. The tool of claim 11, wherein the cam plate defines a cam groove about a central axis of the driven rotor.

14. The tool of claim 13, wherein the positive displacement pump comprises a linear piston and a groove tab received within the cam groove.

15. The tool of claim 13, wherein the cam groove is defined on a bottom face of the driven rotor, opposite of the one or more magnetic elements.

16. The tool of claim 11, wherein driven rotor is axially spaced apart from the drive plate.

17. The tool of claim 11, wherein the motor assembly comprises a drive shaft to which the drive plate is fixed, and wherein the drive shaft is coaxial with and rotationally decoupled from the driven rotor.

18. The tool of claim 11, further comprising a motor fan rotationally coupled to the motor assembly and the drive plate to rotate therewith.

19. The tool of claim 11, wherein the one or more magnetic elements comprises a plurality of circumferentially spaced magnetic elements embedded within the support substrate.

20. The tool of claim 11, further comprising a rotational sensor configured to detect the eddy current and a controller configured to determine an operational state based on the detected eddy current.
